(19) United States
(12) Patent Application Publication
(10) Pub. No.: US 2013/0316555 A1
(43) Pub. Date: Nov. 28, 2013

(54) CONNECTOR ASSEMBLY

(71) Applicants: YU HAN, Shenzhen City (CN); JUN-HUI WANG, Shenzhen City (CN); LI-REN FU, Shenzhen City (CN)

(72) Inventors: YU HAN, Shenzhen City (CN); JUN-HUI WANG, Shenzhen City (CN); LI-REN FU, Shenzhen City (CN)

(73) Assignees: HON HAI PRECISION INDUSTRY CO., LTD., Tu-cheng (TW); HONG FU JIN PRECISION INDUSTRY (ShenZhen) CO., LTD., Shenzhen City (CN)

(21) Appl. No.: 13/490,479

(22) Filed: Jun. 7, 2012

(30) Foreign Application Priority Data
May 23, 2012 (CN) 201210161752.7

(51) Int. Cl. H01R 13/46

(52) U.S. Cl. 439/135

(57) ABSTRACT

A connector assembly includes a connector body, a connecting portion formed on a bottom of the connector body, a number of cables extending up from a top of the connector body, and a cable cover. The cable cover includes a receiving member having a substantially U-shaped cross-section. The receiving member defines a receiving slot in a bottom and an opening in an end. The receiving member is attached to the connector portion through the receiving slot. The cables are bent toward one of opposite ends of the connector body to extend out of the receiving member through the opening.

### BACKGROUND

1. Technical Field

The present disclosure relates to a connector assembly having a connector and a cover for binding cables connected to the connector.

2. Description of Related Art

Connectors for a computer or a server are connected to other components through cables. However, the cables adjacent to the connectors usually need to be pressed down or constrained constantly in order to assemble binding portions or other structures to enclose the components, which is inconvenient. Furthermore, after the components are enclosed, the cables may disperse, and clutter the inside of the computer or server.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a connector assembly including a connector with a first cable cover.

FIG. 2 is an assembled, isometric view of the connector of FIG. 1.

FIG. 3 is side plan view of FIG. 2.

FIG. 4 is assembled, isometric view of the connector of FIG. 1 and a second cable cover.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

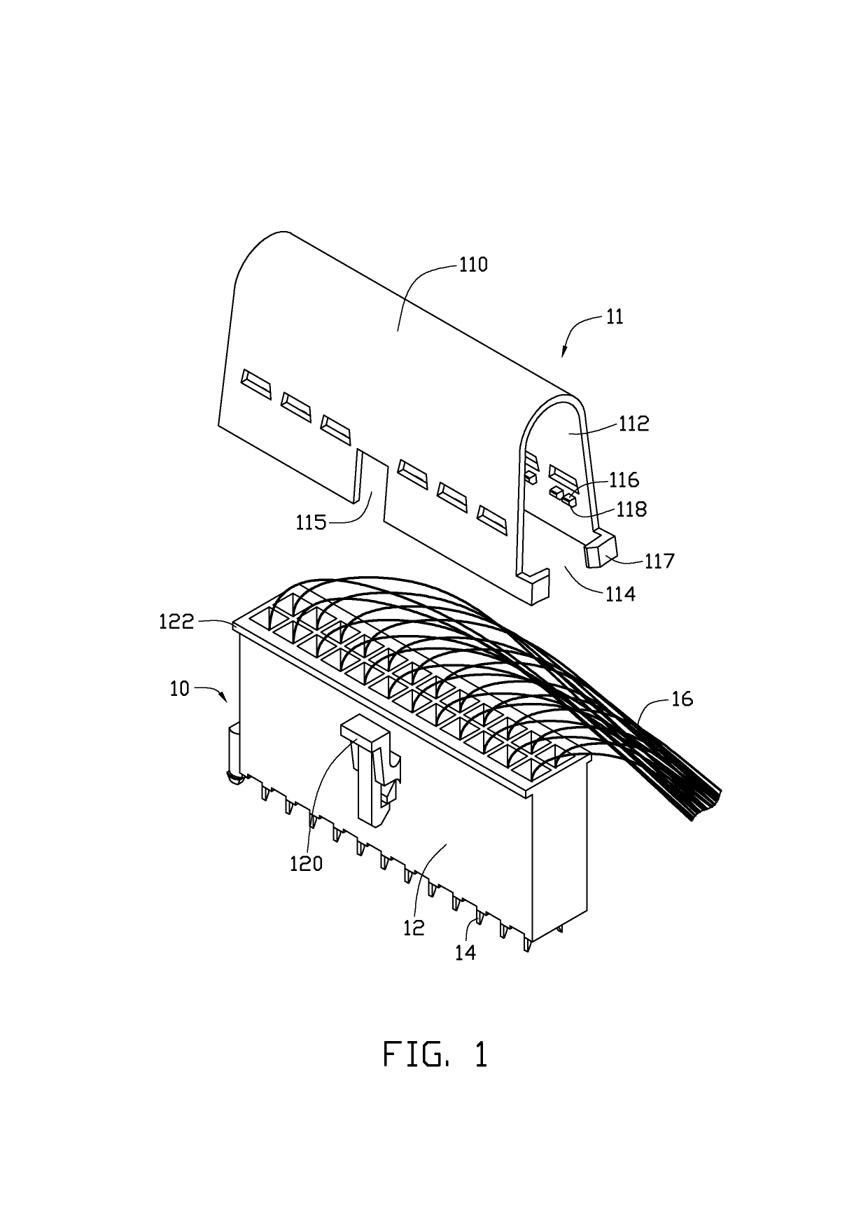

Referring to FIG. 1, an exemplary embodiment of a connector assembly includes a connector body 10 and a cable cover 11. The connector body 10 includes a rectangular main portion 12, a connecting portion 14 formed on a bottom of the main portion 12 to be electrically connected to a circuit board (not shown), and a plurality of cables 16 extending up the main portion 12 and extending through a top of the main portion 12 opposite to the connecting portion 14. A latch 120 is formed on a center of one of opposite side surfaces of the main portion 12, to fix the connector to the circuit board. A flange 122 extends out from a top of each of the opposite side surfaces of the main portion 12.

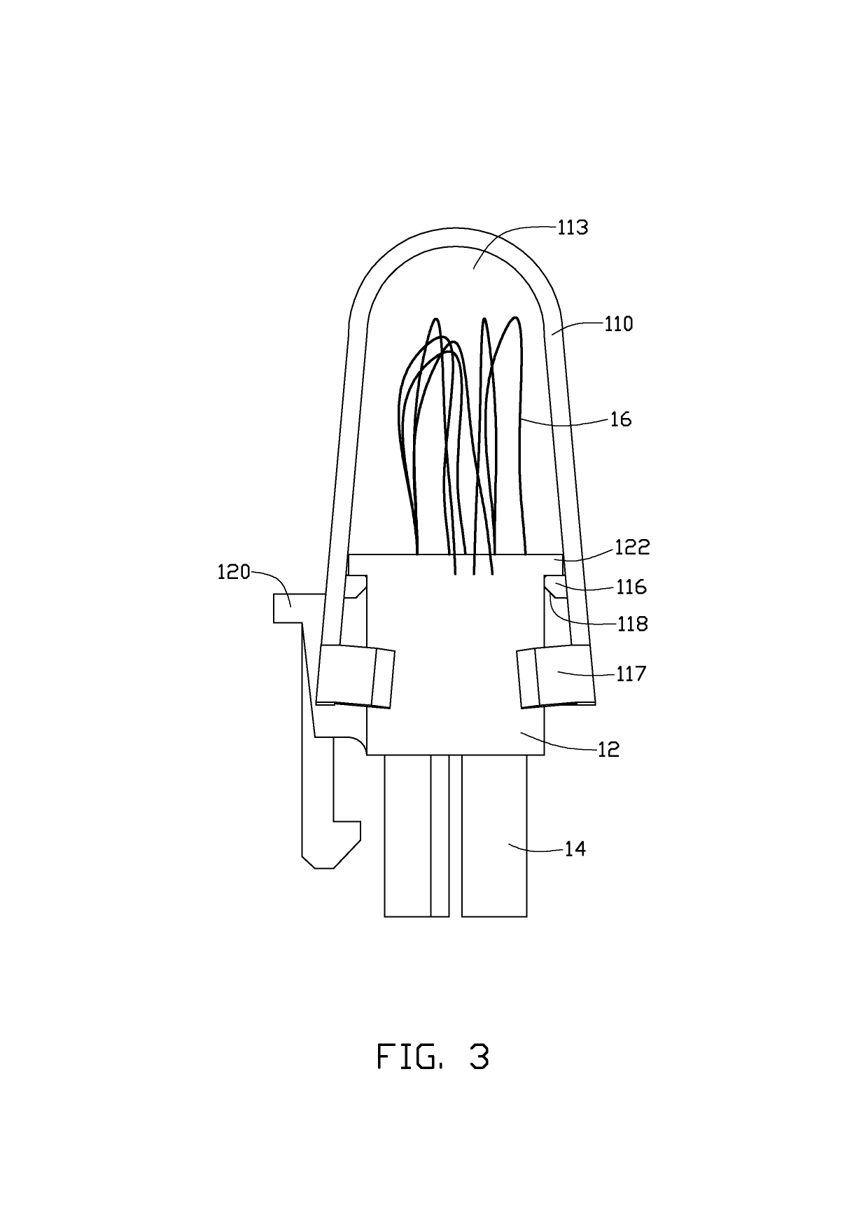

The cable cover 11 includes a receiving member 110 having a substantially U-shaped cross-section. The receiving member 110 defines an opening 112 in a first end, and a blocking piece 113 (shown in FIG. 3) covers a second end of the receiving member 110 opposite to the first end. A rectangular receiving slot 114 is defined in a bottom of the cable cover 11. A cutout 115 communicating with the receiving slot 114 is defined in each of opposite sides of the receiving member 110. Two tabs 117 extend toward each other respectively from lower portions of opposite sides of the receiving member 110 that bounding the opening 112. A row of projections 116 protrudes from each of opposite inner surfaces of the receiving member 110, adjacent to the receiving slot 114. A bottom surface 118 of each projection 116 slantingly extends down from a distal end of the projection 116 toward the corresponding inner surface of the receiving member 110.

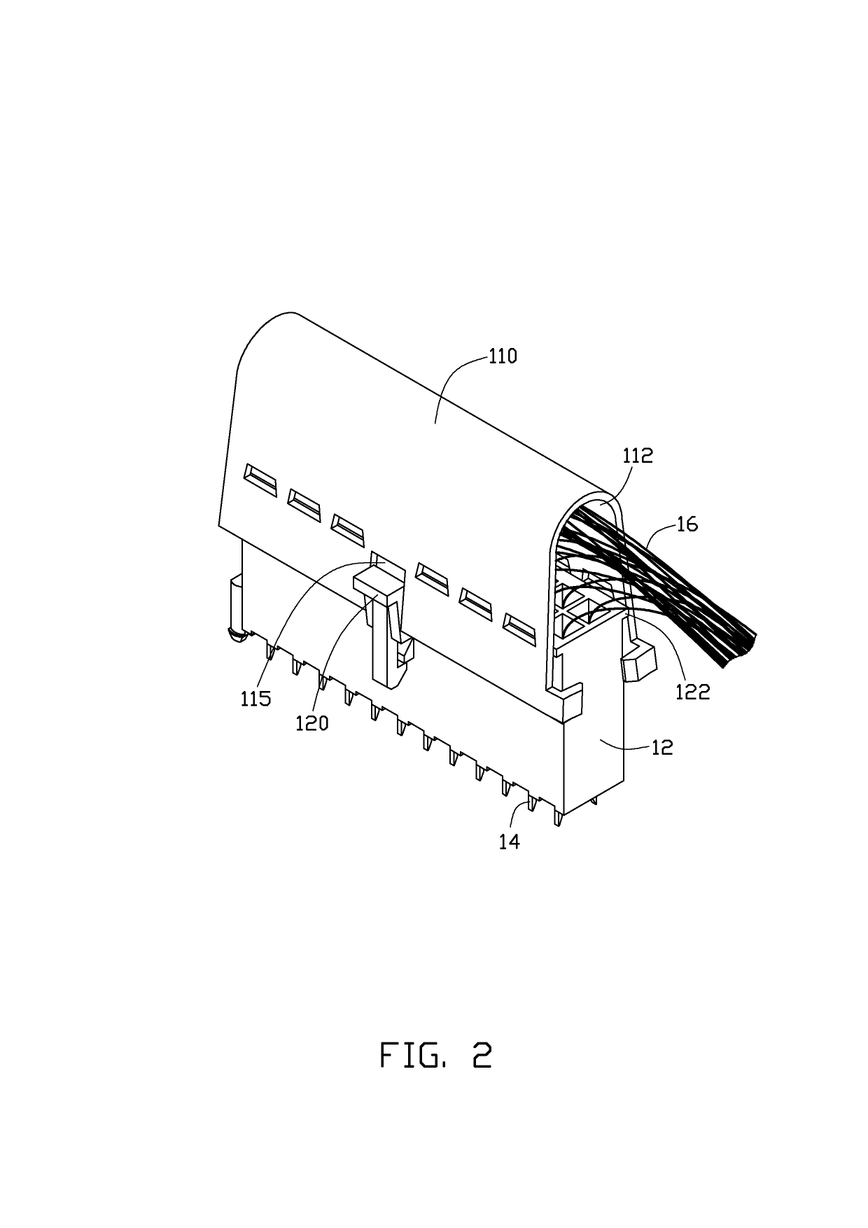

Referring to FIG. 2, in use, the cables 16 are pressed down toward one of the opposite ends of the main portion 12. The cable cover 11 is then attached to the main portion 12, until the bottom surfaces 118 passing the corresponding flange 122 to allow top surfaces of the projections 116 to engage with bottom surfaces of the corresponding flanges 122. At this time, the blocking piece 113 and the tabs 117 are respectively abutted against opposite ends of the main portion 12. An upper portion of the latch 120 is received in the cutout 115. The cables 16 extend out of the cable cover 11 through the opening 112.

In releasing the cables 16, the tabs 117 are deformed away from each other, allowing opposite sides of the receiving member 110 to be deformed away from each other. The cable cover 11 is readily disengaged from the main portion 12. After the cable cover 11 is taken away, the cables 16 may be bent randomly.

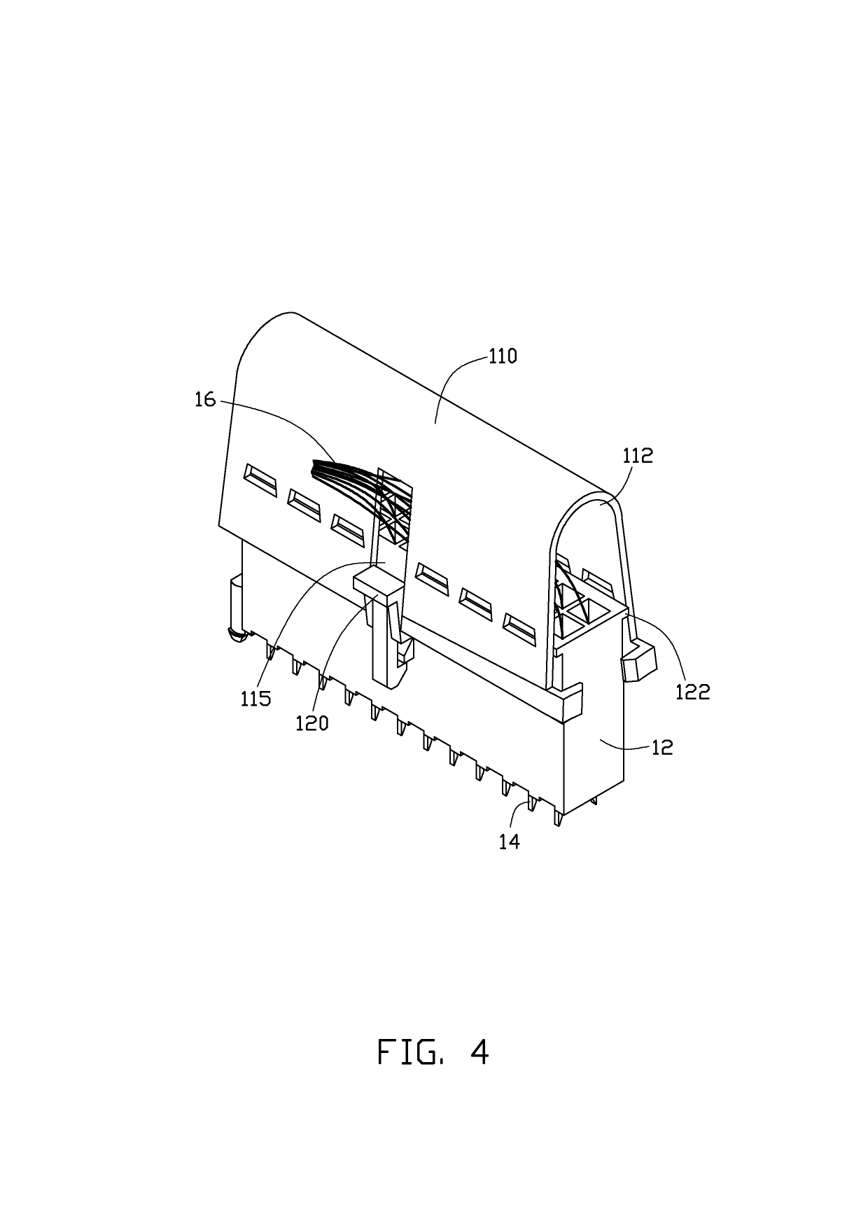

Referring to FIG. 4, in another embodiment, the size of the cutouts 115 may be increased, so that, the cables 16 may extend out of the cable cover 11 through one of the cutouts 115.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A connector assembly, comprising:
a connector body;
a connecting portion formed on a bottom of the connector body;
a plurality of cables connected to the connecting portion and extending up from a top of the connector body opposite to the connecting portion; and
a cable cover comprising a receiving member having a substantially U-shaped cross-section, the receiving member defining a receiving slot in a bottom, and an opening in one of opposite ends;
wherein the receiving member is operable to enclose the connector body through the receiving slot; the cables are operable to be bent toward an end of the connector body adjacent to the opening to extend out of the receiving member through the opening.

2. The connector assembly of claim 1, wherein the receiving member forms a blocking piece covering the other end of the receiving member.

3. The connector assembly of claim 2, wherein two tabs extend toward each other respectively from lower portions of opposite sides of the receiving member that bounding the opening.

4. The connector assembly of claim 1, wherein a flange extends out from a top of each of opposite side surfaces of the connector body, a row of projections protrude from each of opposite inner surfaces of the receiving member to engage with bottoms of the corresponding flanges.

5. The connector assembly of claim 1, wherein a cutout communicating with the receiving slot is defined in each of opposite sides of the receiving member, the cables are operable to be bent toward one of the sides of the connector body to extend out of the receiving member through one of the cutouts.
